(19) United States
(12) Patent Application Publication
(10) Pub. No.: US 2011/0220846 A1
(43) Pub. Date: Sep. 15, 2011

(54) NON-DENSIFIED BIOMASS GASIFICATION METHOD AND APPARATUS

(76) Inventors: Gary M. Banowetz, Corvallis, OR (US); Hossien El-Nashaar, Corvallis, OR (US); Jeffrey J. Steiner, Annapolis, MD (US); David Gady, Rockford, WA (US)

(21) Appl. No.: 12/687,639

(22) Filed: Jan. 14, 2010

(51) Int. Cl. C01B 3/02; B01J 7/00

(52) U.S. Cl. 252/373; 422/129; 422/232; 422/234; 422/167

(57) ABSTRACT

A non-densified feedstock is fed into a modified countercurrent gasifier, and syngas and char are produced from an upper portion of the gasifier. In the preferred embodiment, propane gas is injected into a lower portion of the gasifier as unconsolidated straw feedstock is metered into a gasifier feedstock inlet. The feedstock is converted into syngas and char in a combustion section of the gasifier. A portion of the syngas and char is recycled within the gasifier. After the syngas and char flow out of a gasifier production outlet, the char is separated from the syngas in a cyclone separator. The syngas is used to produce power at the facility where the syngas is produced.

### FIELD OF THE INVENTION

The present invention relates to a method and apparatus for gathering and converting biomass to syngas. Specifically, non-densified agricultural by-products (such as straw and chaff) are used as a feedstock material for a modified countercurrent gasifier. The modified countercurrent gasifier converts the feedstock materials into a syngas and char.

### BACKGROUND OF THE INVENTION

Multiple processes currently exist for converting various plant-based materials into energy. Most of the current gasification processes have shown the greatest utility with wood and various compacted or densified materials. Many of the previous gasification technologies that have proven useful for high alkali, high silicon containing biomass like straw have been based on designs that include a “fluidized bed” configuration that requires (among other things) the utilization of sand or other solid materials to create a uniform and consistent heat gradient within the gasifier. Other biomass gasification reactors utilize “updraft” or “downdraft” designs. However, many of these processes specifically prohibit the use of grass and cereal straws as feedstock because at high operating temperatures (generally required for the gasification of wood), the burning of straws results in the formation of glass-like slag. The formation of slag is due to high concentrations of silicon and alkalis that are present in cereal and grass straws. The slag disrupts the gasification process and decreases the efficiency and net energy yield of the process. The modified countercurrent gasifier process of the current invention does not utilize fluidized bed technology.

Other recycling processes that use straw require transportation of the straw to a bio-refinery or to a recycling facility. However, transportation costs reduce the net benefits of the bio-energy generation process and in some cases may exceed the revenues generated by the process.

Although straw is among the most plentiful of agricultural by-product resources, there are a very limited number of applications in which straw can be profitably utilized and exploited. The need exists for an energy generating means that allows farmers and producers to directly convert straw into usable energy with minimal processing and transportation costs. The current invention discloses a method and apparatus that allows straw to be directly converted into syngas and char. The energy generation process of the current invention is relatively simple and can operate on a single-farm scale so that transportation costs are minimized and the energy generated from the process is usable on the farm where the straw is produced.

### SUMMARY OF THE INVENTION

The current invention is directed to a syngas production system. The syngas production system comprises a modified countercurrent gasifier. The modified countercurrent gasifier includes a fuel gas inlet, a feedstock inlet that is above the fuel gas inlet, a production outlet that is above the feedstock inlet, and a recirculation tube that has an inlet above the feedstock inlet, and an outlet below the feedstock inlet.

In operation, as the feedstock is metered into the gasifier through the feedstock inlet, the gasifier converts the feedstock into syngas and char, and produces the syngas and char through the production outlet. In the preferred embodiment, the syngas is separated from the char by a cyclone separator. The syngas is then used to power a generator at the facility where the syngas is produced.

The current invention is also directed to a method of producing syngas. The method includes the steps of providing a modified countercurrent gasifier and metering a non-densified straw feedstock into the gasifier. Char and syngas are then produced from an upper portion of the gasifier.

### BRIEF DESCRIPTION OF THE DRAWINGS

FIG. 1 is a schematic of the process of the current invention.

FIG. 2 is a modified schematic of the syngas production system of the current invention.

### DETAILED DESCRIPTION OF PREFERRED EMBODIMENTS

The present invention comprises a method and apparatus for collecting non-densified biomass and converting the biomass to syngas and char that can be used at a facility where the biomass is generated. Although the preferred embodiment of the current invention is directed to the use of grass and cereal straws, other types of straw as well as cellulosic and non-cellulosic biomass should be considered within the scope of the current invention.

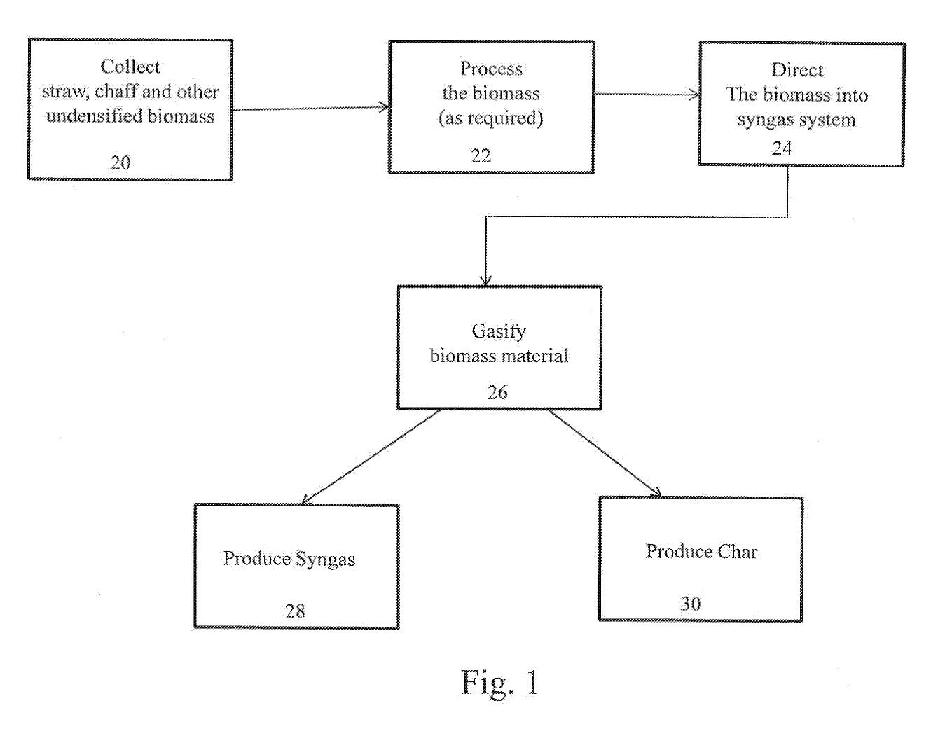

In the first step of the current process, non-densified biomass materials are gathered. This process is represented as the “Collect” step 20 shown in FIG. 1.

In the preferred embodiment, at the conclusion of a growing season, wheat (for example) is harvested in a conventional manner and the straw is combined and compiled into a windrow. A self-propelled chopper picks up the windrow, “processes” the straw, and blows the straw into a truck so that the truck transports a load of processed straw (i.e. non-densified cellulosic biomass) to a holding/storage area. In the holding area, the straw is combined with chaff and other similar cellulosic agricultural by-products that have also been processed or otherwise reduced to a similar state as the straw.

In the preferred embodiment, the straw is “processed” by cutting the straw during a field chopping operation into lengths of approximately two inches so that the straw has a form that is usable as feedstock for the current invention. In alternative embodiments, the straw/feedstock may be processed into lengths of greater or less than two inches based on the nature of the feedstock and the capability of the hopper and/or feedstock conveyance system. The amount and type of “processing” required is dependent upon the nature of the straw or other cellulosic biomass gathered. The reduction of the straw and other agricultural by-products into a feedstock form is represented as the “Process” step 22 shown in FIG. 1.

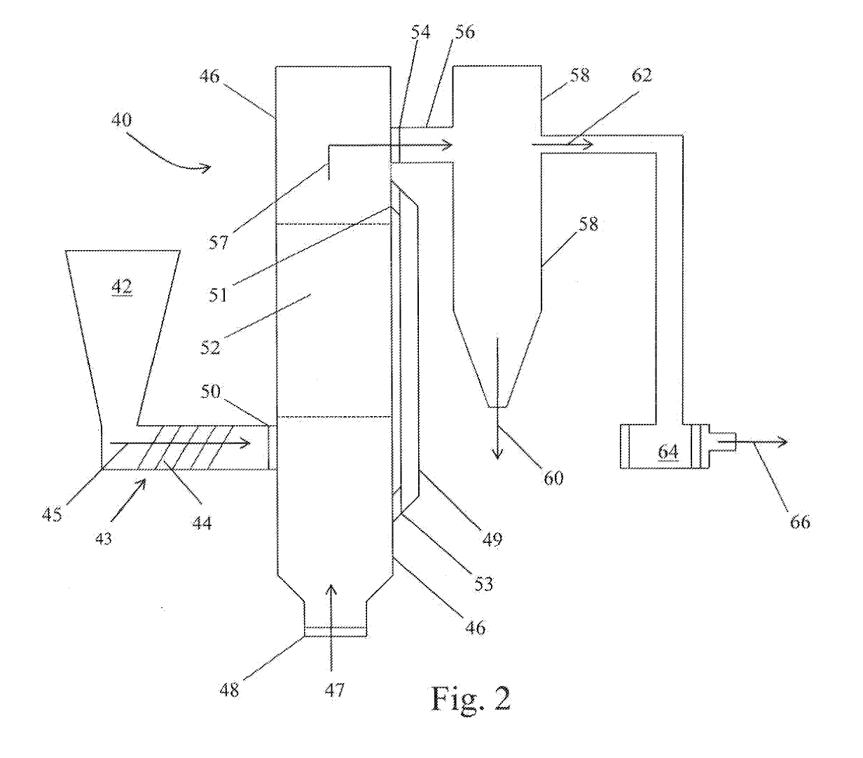

From the holding area, the processed biomass is directed into the syngas production system 40 (see FIG. 2) of the current invention. Specifically, the biomass feedstock is directed into the feedstock hopper 42 (see FIG. 2) The process of directing the biomass into the syngas production system 40 is represented as the “Direct” step 24 shown in FIG. 1. A modified countercurrent gasifier 46 (see FIG. 2) within the syngas production system 40 gasifies the biomass feedstock. The gasification process is represented as the “Gasify” step 26 shown in FIG. 1.

Through the gasification process, the biomass feedstock is converted into syngas and char. The process of producing syngas from the gasified feedstock is represented by the “Produce Syngas” step 28 shown in FIG. 1. The char production process is represented by the “Produce Char” step 30 also shown in FIG. 1.

The syngas production system 40 generally shown in FIG. 2 will now be discussed in detail.

As noted supra and generally shown in FIG. 2, once the biomass feedstock has been collected and processed, the feedstock is directed to a feedstock hopper 42. Although the hopper 42 is generally shown as having a conical shape, the hopper 42 may have any form known in the art consistent with the process of the current invention. The hopper 42 directs the feedstock into a conveyance system 43 which transfers the feedstock into the countercurrent gasifier 46 in the direction of the arrow 45.

In the preferred embodiment, the feedstock conveyance system 43 comprises an auger 44 which continuously moves the feedstock into the body of the gasifier 46. In alternative embodiments, the feedstock may be continuously moved into the gasifier 46 by any means known in the art consistent with the process of metering the feedstock into the gasifier 46.

As shown in FIG. 2 and noted supra, in the preferred embodiment, the gasifier 46 comprises a “modified countercurrent gasifier”. For the purposes of this invention, a “modified countercurrent gasifier” 46 is defined as a reactor wherein a source of oxygen (typically air) and a fuel gas are initially forced into a lower inlet port 48 (in the direction of the arrow 47), and a syngas and entrained char are produced from a production outlet 54 near the top of the gasifier 46 (in the direction of the arrow 57). A modified countercurrent gasifier 46 does not include a fluidized bed.

In a modified countercurrent gasifier 46 system, oxygen and fuel gas are initially ignited within the gasifier 46 to bring the gasifier 46 to operating temperature. Biomass feedstock is then fed into the gasifier 46. After feedstock ignition occurs, the supply of fuel gas is discontinued and combustion within the gasifier 46 is self-sustaining as a result of the continuous ignition of the biomass. Feedstock is directed into the modified countercurrent gasifier 46 through an intermediate port 50 above the lower inlet 48. A recirculation tube 49 recycles a portion of the syngas and entrained char from an area above the intermediate port 50 to an area below the intermediate port 50.

In the preferred embodiment, air (that includes oxygen) may be used in combination with the fuel gas. The operating temperature in the area of the gasifier 46 adjacent to the intermediate port 50 is near the maximum temperature achieved by the burning of the fuel gas. Cellulosic feedstock combined with the air and propane (the fuel gas) combusts in a gasifier combustion zone 52 above the intermediate feedstock inlet port 50.

The recirculation tube 49 re-circulates a portion of the syngas with entrained char from an upper recirculation port 51 to a lower recirculation port 53. Recycling the syngas and entrained char improves the efficiency of the conversion of biomass carbon into combustible components of syngas and char. As discussed supra, the remaining syngas with entrained char is produced from an upper production outlet port 54 of the gasifier 46 in the direction of the arrow 57.

The modified countercurrent gasifier 46 of the current invention is distinguishable from prior art gasifiers because (among other things) the modified countercurrent gasifier 46 does not utilize a fluidized bed or additional complicating elements. The modified countercurrent gasifier 46 of the current invention functions most efficiently and effectively when a relatively homogenous and combustible processed cellulosic feedstock (like straw which includes chaff) is used. Using this type of feedstock, the gasifier 46 is able to operate at temperatures that are generally below 1400° F., and thereby avoid the formation of glass-like slag (discussed supra) that is generally associated with cereal grass feedstocks.

As shown in FIG. 2, the upper outlet port 54 directs the syngas and entrained char through a connecting tube 56 in the direction of the arrow 57 to a cyclone separation apparatus 58 of the type that is well known in the art. The cyclone separation apparatus 58 removes the entrained char and directs the produced char out of the cyclone vessel 58 in the direction of the arrow 60. In an alternative embodiment, a secondary cyclone or “baghouse” may be required to remove additional particulate matter from the syngas. In further alternative embodiments, the char may be removed by any means known in the art.

The syngas is then directed out of the cyclone separation apparatus 58 in the direction of the arrow 62 to be used in any means known in the art. In the preferred embodiment, a blower motor 64 propels the syngas in the direction of the arrow 66 to an electrical generator which produces electrical power to be used at the facility where the biomass originates.

For the foregoing reasons, it is clear that the invention provides an innovative method and apparatus for the gasification of biomass to produce syngas and char that have utility in downstream processes. The invention may be modified in multiple ways and applied in various technological applications. The current invention may be customized as required by a specific operation or application, and the individual components may be modified and defined, as required, to achieve a desired result. Although the materials of construction are not described, they may include a variety of compositions consistent with the function of the invention. Such variations are not to be regarded as a departure from the spirit and scope of the invention, and all such modifications as would be obvious to one skilled in the art are intended to be included within the scope of the following claims.

What is claimed is:

1. A syngas production system comprising:
a modified countercurrent gasifier, the gasifier comprising:
(a) a fuel gas inlet;
(b) a feedstock inlet above the fuel gas inlet;
(c) a production outlet above the feedstock inlet;
(d) a recirculation tube having a recirculation tube inlet above the feedstock inlet, and a recirculation tube outlet below the feedstock inlet;
wherein a feedstock is metered into the gasifier through the feedstock inlet, the gasifier converting the feedstock into syngas and char, and producing the syngas and char through the production outlet.

2. The system of claim 1 wherein the feedstock is non-densified biomass.

3. The system of claim 1 wherein the feedstock is non-densified cellulosic material.

4. The system of claim 1 wherein the feedstock is straw.

5. The system of claim 4 wherein the feedstock is grass straw or cereal straw.

6. The system of claim 4 wherein the straw is cut, processed, and loaded into a transportation vehicle and transported in a non-densified form.

7. The system of claim 4 wherein processing the straw comprises cutting the straw into lengths in a range of one to three inches.

8. The system of claim 1 further comprising a gasifier combustion section, the gasifier being structured so that the combustion section is located between the recirculation tube inlet and the feedstock inlet.

9. The system of claim 8 wherein combustion occurs in the combustion section, the combustion temperature being below 1400° F.

10. The system of claim 1 wherein syngas and char are recirculated through the recirculation tube.

11. The system of claim 1 wherein the syngas is separated from the char in a cyclone separator.

12. The system of claim 1 wherein the feedstock is initially deposited into a hopper and metered to the feedstock inlet by a conveyance system.

13. The system of claim 12 wherein the conveyance system comprises an auger.

14. The system of claim 1 wherein a fuel gas is injected into the fuel gas inlet until the gasifier reaches a preselected operating temperature, the injection of the fuel gas is then terminated and ignition of the feedstock is continuously self-sustaining.

15. The system of claim 1 wherein propane is injected into the fuel gas inlet.

16. The system of claim 1 wherein the gasifier is structured as an essentially hollow vertically oriented cylinder, the fuel gas being injected into a lower portion of the cylinder and the syngas and char being produced from an upper portion of the cylinder.

17. An apparatus for producing syngas and char comprising:
an unconsolidated straw feedstock;
a gas fuel;
a modified countercurrent gasifier;
wherein as the gas fuel is injected into a lower portion of the gasifier, the feedstock is metered into an intermediate portion of the gasifier so that the gasifier converts the feedstock into sygas and char, which are produced from an upper portion of the gasifier.

18. The apparatus of claim 17 wherein after the gasifier reaches a preselected operating temperature, fuel gas flow is terminated and the conversion of feedstock into sygas and char is a self-sustaining process.

19. A method of producing syngas comprising the steps of:
providing a modified countercurrent gasifier;
metering a straw feedstock into the gasifier;
producing syngas and char from a production outlet in an upper portion of the gasifier.

20. The method of claim 19 wherein the straw feedstock is cut, processed, transported, and metered into the gasifier in a non-densified form.
